(19) United States
(12) Patent Application Publication
(10) Pub. No.: US 2026/0261225 A1
(43) Pub. Date: Sep. 3, 2026

(54) ARRANGEMENT FOR AN ELECTRIC MACHINE

(71) Applicant: Rolls-Royce Deutschland Ltd & Co KG, Blankenfelde-Mahlow (DE)

(72) Inventors: Wolfram BIRKMAYER, Hirschaid (DE); Marco BOHLLÄNDER, Hirschaid (DE); Andreas REEH, Nürnberg (DE); Tadele YIRISAW, Derby (GB)

(21) Appl. No.: 19/165,152

(22) PCT Filed: Feb. 29, 2024
(86) PCT No.: PCT/EP2024/055284

§ 371 Date: Sep. 15, 2025

(30) Foreign Application Priority Data
Mar. 16, 2023 (DE) 10 2023 106 666.8

(51) Int. Cl. H02P 29/024

(52) U.S. Cl. CPC H02P 29/024

(57) ABSTRACT

An arrangement (1) for an electric machine (2; 2′) comprises: an assembly (21) having a body (10) and multiple windings (12A-12C), each of which has a first electrical conductor (120) and a second electrical conductor (121) that are wound at least in one winding section (122) along a winding axis (A) and alternate in at least one direction, in particular in the direction of the winding axis (A); multiple sensors (140) arranged at at least two points (X1, X2, X5, X6) of the first electrical conductor (120) and two points (X3, X4, X7, X8) of the second electrical conductor (121) of at least one of the windings (12A-12C) in order to measure a respective electrical variable; and a unit (131) set up to measure a first difference between the electrical variable at the two points (X1, X2, X5, X6) of the first electrical conductor (120) and a second difference between the electrical variable at the two points (X3, X4, X7, X8) of the second electrical conductor (121) and to output an output signal based on a deviation between the first difference and the second difference.

The present disclosure relates, in particular, to an arrangement for an electric machine, an electric machine having such an arrangement, an aircraft having such an electric machine and to a method for monitoring an electric machine.

Arrangements of this kind include an assembly having a body, for example in the form of a laminated core, and a plurality of windings which are wound around teeth of the body, for example. By applying voltages to the windings, particularly voltages that vary over time, magnetic fields are generated which, for example, cause a relative movement between the assembly and a further assembly. The assembly is, for example, a stator and the further assembly is a rotor.

Especially in polyphase rotating field machines, in particular having a permanently excited rotor, it proves to be problematic if a short circuit between turns occurs inside a winding. In electric machines of this kind in particular, the problem exists that, in the event of a short circuit between turns during intended operation, a large electric current can be induced, which current can result in thermal destruction of the windings. This is particularly relevant not only, but particularly, in aircraft in which, for example, permanently excited rotating field machines are used.

If, for example, a short circuit between turns of this kind is identified, the electric machine, or part of it, may be switched off. In the aviation sector, however, such a switch-off can have far-reaching consequences. It is therefore desirable to perform such a shutdown only when this is actually necessary.

The object of the present invention is to specify an arrangement for an electric machine that is as reliable as possible.

According to one aspect, an arrangement for an electric machine is specified, the arrangement comprising an assembly having a body and a plurality of windings (for example tooth windings), each of which has a first electrical conductor and a second electrical conductor which are wound at least on one winding portion along a winding axis (for example around the same tooth of a plurality of teeth anchored on the body) and alternate, for example, in the direction of the winding axis; a plurality of sensors, which are arranged at least at two points of the first electrical conductor and two points of the second electrical conductor of at least one of the windings in order to detect an electrical variable in each case; and a unit, which is configured to detect a first difference in the electrical variable at the two points of the first electrical conductor and a second difference in the electrical variable at the two points of the second electrical conductor and to output an output signal based on a deviation between the first difference and the second difference.

An arrangement of this kind makes it possible to particularly reliably identify a short circuit between adjacent turns of a winding portion, that is to say between the corresponding first and second electrical conductor, in order to initiate countermeasures, such as switching off a power supply, and to shut down an electric machine having the arrangement in safe operation in order to avoid dangerous operating states. By detecting the deviation between the first difference and the second difference, it is possible to ascertain whether the difference detected or the differences detected is/are a measurement error or measurement errors due to a defective sensor or an actual short circuit. Unnecessary switch-off operations can be avoided as a result. At least at the winding portion or the winding portions (optionally completely), the first electrical conductor and the associated second electrical conductor are electrically insulated from each other. The magnitudes of the differences can always be used here. The unit can also be referred to as an evaluation unit or analysis unit. The unit may comprise a microcontroller or alternatively merely an analog circuit.

The sensors are designed, for example, in the form of current sensors for measuring a current through the respective electrical conductor. The current sensor comprises, for example, a Hall sensor and/or a loop sensor. This enables detection of a fault based on current signals using two separate electrical conductors. This enables reliable identification of short circuits.

The at least two points of the respective electrical conductor can be electrically connected to each other via the respective winding portion. This makes a difference measurement possible, which allows particularly reliable identification of faults.

The unit is configured, for example, to output the output signal when the deviation is greater than a specified deviation threshold value, wherein the output signal indicates a sensor fault. A short circuit between turns relates to both electrical conductors. By way of the unit identifying that the two difference values are different, the unit can conclude that there is no short circuit between turns, but rather a sensor fault.

The unit can be configured to output an output signal, which indicates a line fault, when the first difference and/or the second difference are/is greater than a specified difference threshold value and the deviation is smaller than a specified deviation threshold value. Therefore, if the same difference is measured on both electrical conductors within the scope of measurement accuracy, the unit can conclude that there is no sensor fault, but actually a short circuit.

The unit can be configured to output the output signal only when the first difference and/or the second difference over a specified time period is greater than the specified difference threshold value. In this way, short fluctuations in the measured signals, for example as a result of noise due to external disturbances, can be filtered.

Optionally, the unit is configured to detect the first difference and/or the second difference as a mean average over a specified time window. In this way, fluctuations in the measured signals can be smoothed. For example, the unit is configured to determine the first difference and/or the second difference as an RMS value. As an alternative or in addition, the unit is, for example, configured to extract a predetermined frequency range from values of the detected electrical variable by means of filtering, in particular bandpass filtering and further to analyze this partial signal, in particular by the described calculation of the difference. The predetermined frequency range is aligned, for example, with one or more characteristic frequencies in the signals.

Optionally, a sensor is arranged at one point of the at least two points of the first electrical conductor and/or a (further) sensor is arranged at a (further) point of the at least two points of the first electrical conductor and/or a (further) sensor is arranged at one point of the at least two points of the second electrical conductor and/or a (further) sensor is arranged at a (further) point of the at least two points of the second electrical conductor. This enables accurate measurement with a simple design.

As an alternative or in addition, a sensor for measuring a differential current of the first electrical conductor is optionally arranged at points of the first electrical conductor that are electrically connected to each other via the winding portion and/or a (further) sensor for measuring a differential current of the second electrical conductor is arranged at points of the second electrical conductor that are electrically connected to each other via the winding portion. This enables particularly accurate measurement with few sensors.

The arrangement can comprise an inverter, in particular with a plurality of inverter units, each for one electrical phase of a polyphase electrical AC voltage. This enables the use of a DC voltage source such as a battery. The inverter units are optionally electrically connected to the first electrical conductors of each of the windings and/or the inverter units are electrically connected to the second electrical conductors of each of the windings. All of the inverter units can be supplied with energy from the same energy source.

The arrangement comprises, for example, (in particular exactly) three windings, each for one phase of a three-phase AC current. The arrangement thus comprises, for example, six (first and second) electrical conductors in total.

All of the first electrical conductors of each of the windings can be electrically connected to each other at a (first) star point. Furthermore, all of the second electrical conductors of each of the windings can be electrically connected to each other at a (second) star point. This enables a particularly simple design. The arrangement can comprise one or more voltage sensors as sensor(s). Optionally, the voltage sensor (or the voltage sensors) is (are each) connected in such a way that it (they each) can measure a voltage at one or both star points, for example with reference to an earth potential. As an alternative or in addition, a voltage sensor is connected to both star points in order to measure a voltage between the star points.

In particular, the first and the second electrical conductor are arranged in a bifilar manner (at least on at least one winding portion). Due to the fact that the turns of the first and the second electrical conductor are arranged in a bifilar manner, a short circuit between turns may thus initially occur between the first and the second electrical conductor. If an electrical charge is applied to the winding elements formed by the first and the second electrical conductor, it is thus possible to considerably reduce the effect of a short circuit between turns.

For example, each of the first electrical conductors of the windings runs around each of a plurality of teeth and/or each of the second electrical conductors of the windings runs around each of a plurality of teeth, in particular in each case around the same teeth as the associated first electrical conductor.

According to one aspect, an arrangement for an electric machine is specified, in particular according to any of the refinements described above. The arrangement comprises an assembly having a body and a plurality of windings. The windings each have a first electrical conductor and a second electrical conductor which are wound at least on one winding portion along a winding axis (for example around the same tooth of a plurality of teeth anchored on the body) and alternate in at least one direction, in particular in the direction of the winding axis. The first electrical conductors of the windings are electrically connected to each other at a first star point. The second electrical conductors of the windings are electrically connected to each other at a second star point. The arrangement further comprises a first inverter arrangement with inverter units and a second inverter arrangement with further inverter units. The inverter arrangements each have an inverter unit for each phase of a polyphase (for example three-phase) electrical AC voltage, wherein each of the first electrical conductors of the windings is electrically connected to an inverter unit of the first inverter arrangement and each of the second electrical conductors of the windings is electrically connected to an inverter unit of the second inverter arrangement. The arrangement further comprises one or more sensors (each) for detecting measured values of an electrical variable (for example current) of one or more of the first or second electrical conductors, and one unit. The unit is configured to receive the measured values of the sensor or the sensors, to determine at least one value, which is indicative of a sum of the electrical variable of the first electrical conductor and/or the second electrical conductor, based on one or more of the measured values, and to output an output signal based on the at least one value determined.

An arrangement of this kind also makes it possible to particularly reliably identify a short circuit between adjacent turns of a winding portion, that is to say between the corresponding first and second electrical conductor, in order to initiate countermeasures, such as switching off a power supply as mentioned above, and to shut down an electric machine having the arrangement in safe operation in order to avoid dangerous operating states. If the sum of the measured values of the electrical variable, for example current (or one of the sums), is significantly different from zero, this may indicate a short circuit between turns because the alternating conductors at the short-circuited point cause current to drain from a conductor that is connected to one of the inverter arrangements to a conductor that is connected to the other of the inverter arrangements. However, in a conventional, for example three-phase, electric machine, in the case of a short circuit between turns, the conductor (forming a loop) is only short-circuited with itself, so that a short circuit cannot be readily identified from the sum of the electrical variable of the first or second electrical conductors (this is particularly true for low-inductance electric machines). If both sums are equally different from zero, a sensor fault, which would lead to a result different from zero only in one of the two sums, can additionally be excluded. In particular, if the individual sensors have a different characteristic curve, provision may be made for the unit to be configured to calibrate one or both sensors.

The unit can be configured to determine a (first) value, which is indicative of a sum of the electrical variable of the first electrical conductors, based on one or more of the measured values and/or to determine a (second) value, which is indicative of a sum of the electrical magnitude of the second electrical conductors, based on one or more of the measured values. The unit can be configured to determine a (first) sum of the currents through the first conductors as the value and/or to determine a (second) sum of the currents through the second conductors as the value (or as further value) based on one or more of the measured values.

The unit can further be configured to ascertain a first zero sequence current of the first electrical conductors and/or a second zero sequence current of the second electrical conductors, for example based on the sum determined (or the sums determined). For this purpose, the control unit calculates l0=1/3*(lu+lv+lw), where l0 indicates the zero sequence current, while lu, lv and lw indicate the currents of the respective phases (through the respective first or second electrical conductors).

The unit can further be configured to identify a fault on one of the first conductors when the first value and/or the first zero sequence current (for example the maximum amplitude of the first zero sequence current) exceeds a specified threshold value. As an alternative or in addition, the unit is configured, for example, to identify a fault on one of the second conductors when the second value and/or the second zero sequence current (for example the maximum amplitude of the second zero sequence current) exceeds a specified threshold value. Provision may be made for the output signal to indicate a fault when the control unit has identified a fault on one of the first conductors and/or has identified a fault on one of the second conductors. This can significantly reduce the probability of a false alarm, for example as a result of measurement errors. The two values can therefore be checked for plausibility. If both deviate equally (in particular from zero) (in particular with the same or calibrated sensor characteristic curves), then there is a fault in a conductor.

In one refinement, the unit is configured to identify the presence of a first type of fault either when there is a fault on one of the first conductors or sensors (but no fault is identified by means of the sensors of the second conductors) or there is a fault on one of the second conductors or sensors (but no fault is identified by means of the sensors of the first conductors). The unit can also be configured to identify the presence of a second type of fault when there is a fault on one of the first conductors and there is a fault on one of the second conductors (in this case, the same fault in both sensors can be ruled out due to the probabilities). This allows various fault states to be identified and indicated.

For example, the output signal indicates a sensor fault when the unit identifies the first type of fault, and indicates an insulation fault when the unit identifies the second type of fault. If there is a short circuit between turns due to an insulation fault, currents then flow between the conductors of the actually separate conductor systems. This results in zero sequence currents (and sums) that differ from zero in both conductor systems. If, however, a fault is identified only in one of the two conductor systems, the cause of this fault is a measurement error, for example due to a defective sensor.

In each case one of the sensors can be arranged on each of the first and second electrical conductors. The sensors can each be arranged in the respective inverter unit or between the respective inverter unit and the winding portion (in particular the next winding portion) respectively connected to this inverter unit. This allows particularly simple connection of the sensors.

The sensors of the first electrical conductors can be connected to each other in series. As an alternative or in addition, the sensors of the second electrical conductors can be connected in series. The two series can be electrically connected to each other at one of their ends in each case, that is to say connected to each other in series. A sensor, for example a voltage sensor, can be connected to the other ends of the series. The voltage sensor is, for example, part of a voltage measuring instrument. This enables reliable identification of an insulation fault with a particularly simple circuit having only one sensor.

The sensor or one of the sensors can surround a plurality, in particular all, of the first electrical conductors. As an alternative or in addition, the sensor or one of the sensors can surround a plurality, in particular all, of the second electrical conductors. Therefore, a value that is proportional to the zero sequence current of the respective conductor system can be determined with only one single sensor (in each case). It should be noted at this point that the sensors can be arranged inside the electric machine or can be arranged outside the electric machine.

The first star point and the second star point can be arranged on the same side of the body. This facilitates a simple design. As an alternative, it is possible for the first star point and the second star point to be arranged on opposite sides of the body. This can make wiring easier.

The sensor or the sensors can be designed as a current sensor or current sensors for measuring a current through the respective electrical conductor or conductors. The current sensor or sensors can (each) comprise a Rogowski coil. This allows for simple and at the same time robust current measurement. Instead of or in addition to a Rogowski coil, the sensor (or each of a plurality of sensors) can be a different current transformer, for example one that uses the Hall effect for measurement. The sensor (or the sensors) can (each) comprise a Hall element and/or a magnetic core at least partially surrounding the conductor.

The unit can be configured to determine at least one harmonic of the value over time and to output the output signal based on this harmonic, in particular to output the output signal indicating a fault, in particular an insulation fault, based on a change in the at least one harmonic over time. This enables particularly reliable fault identification.

According to one aspect, an electric machine is provided. The electric machine comprises the arrangement according to any refinement described herein, for example as a stator. The electric machine further comprises a further assembly, for example in the form of a rotor, wherein the assembly and the further assembly are movable, in particular rotatable, relative to each other.

In the electric machine, the stator provides, for example, a substantially circular opening for accommodating the rotor. The rotor is arranged in the opening, for example in a rotatably mounted manner, wherein an air gap is formed between the rotor and the stator. This type of construction is also referred to as an internal rotor. As an alternative, a type of construction in which the rotor radially surrounds the stator is provided. Constructions of this kind are also called external rotors. The electric machine is an apparatus which converts electrical energy into mechanical energy, in particular kinetic energy, in a motor mode, and/or mechanical energy into electrical energy in a generator mode. The movement is, for example, a rotational movement performed by the rotor. The stator is, for example, arranged in a rotationally fixed manner with respect to a mount bearing the electric machine. A rotational movement is therefore in particular a rotational movement of the rotor in relation to the stator.

According to one aspect, a vehicle, in particular an aircraft, is provided, comprising the electric machine according to any refinement described herein, in particular for driving a thrust-generating apparatus, for example a propeller. The advantages of the electric machine described herein apply especially to a vehicle, in particular an aircraft. However, it should be noted that the arrangement can also be used, for example, in a gas pump, in a marine engine or in a wind turbine or in a generator in general.

According to one aspect, a method for monitoring an electric machine is specified. The method comprises the following steps:
applying electric current to a plurality of windings, each of which has a first electrical conductor and a second electrical conductor which are wound at least on one winding portion along a winding axis (for example around the same tooth of a plurality of teeth of the electric machine, the teeth being anchored on a body) and alternate, for example, in the direction of the winding axis;
detecting an electrical variable with each of a plurality of sensors, which are arranged at least at two points of the first electrical conductor and two points of the second electrical conductor of at least one of the windings;
detecting, by means of a unit, a first difference in the electrical variable at the two points of the first electrical conductor and a second difference in the electrical variable at the two points of the second electrical conductor and determining a deviation between the first difference and the second difference; and
outputting, by means of the unit, an output signal based on the deviation.

The arrangement described above and/or the electric machine described above can be used in the method.

According to one aspect, a method for monitoring an electric machine is specified. The method comprises the following steps:
applying electric current to a plurality of windings, each of which has a first electrical conductor and a second electrical conductor which are wound at least on one winding portion along a winding axis (for example around the same tooth of a plurality of teeth of the electric machine, the teeth being anchored on a body) and alternate in at least one direction, in particular in the direction of the winding axis, by means of a first inverter arrangement with inverter units and a second inverter arrangement with further inverter units, wherein the inverter arrangements each have an inverter unit for each phase of a polyphase electrical AC voltage, wherein each of the first electrical conductors of the windings is electrically connected to an inverter unit of the first inverter arrangement and each of the second electrical conductors of the windings is electrically connected to an inverter unit of the second inverter arrangement and wherein the first electrical conductors of the windings are electrically connected to each other at a first star point and the second electrical conductors of the windings are electrically connected to each other at a second star point;
detecting an electrical variable of one or more of the first or second electrical conductors with each of one or more sensors;
receiving, by means of a unit, the measured values of the sensor or the sensors;
determining, by means of the unit, at least one value, which is indicative of a sum of the electrical variable of the first electrical conductors and/or the second electrical conductors, based on one or more of the measured values; and
outputting, by means of a unit, an output signal based on the at least one value.

Embodiments will now be described by way of example with reference to the figures, in which:

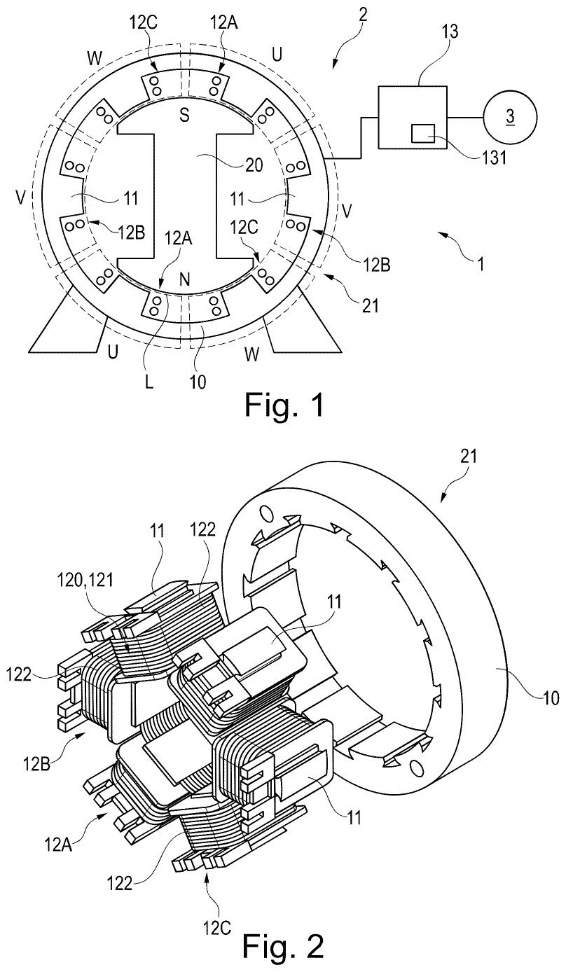

FIG. 1 shows a schematic sectional illustration of a basic design of a permanently excited, three-phase electric machine in the form of an internal rotor;

FIG. 2 shows a schematic, perspective exploded view of a design of an assembly in the form of a stator of the electric machine according to FIG. 1 having windings;

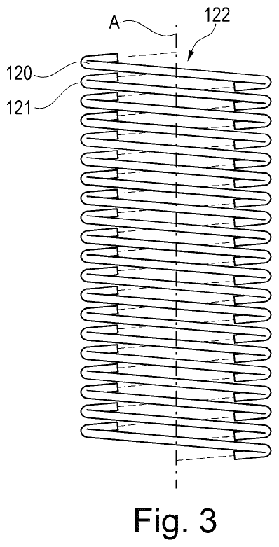

FIG. 3 shows a schematic illustration of part of a winding of the assembly according to FIG. 2, in which turns of a first and a second electrical conductor are arranged in a bifilar manner;

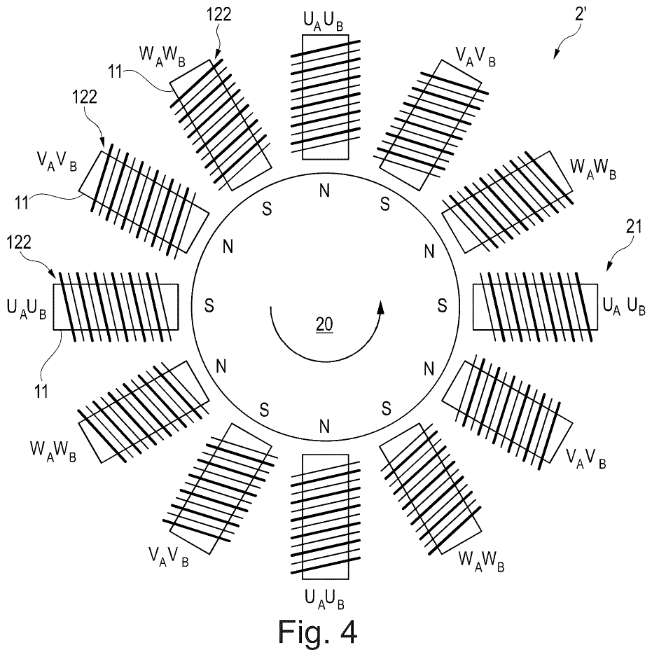

FIG. 4 shows a schematic illustration of a permanently excited electric machine for operation at a three-phase electrical AC voltage;

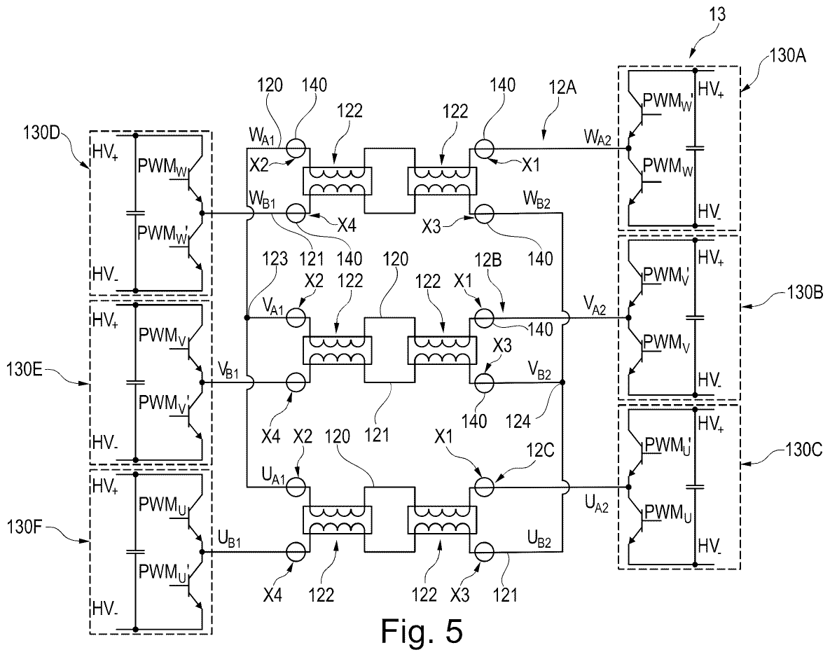

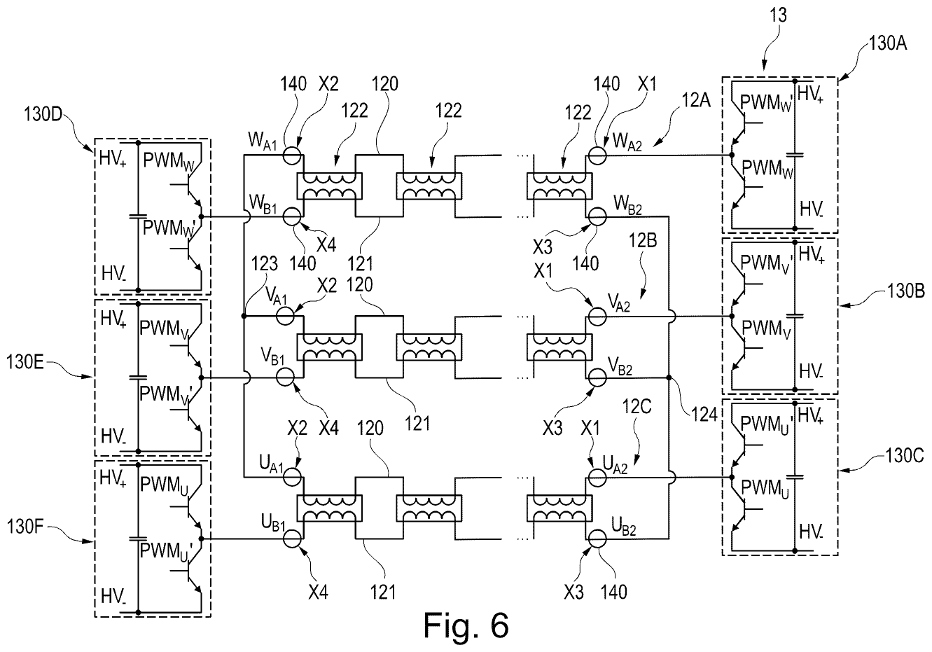

FIGS. 5 and 6 show schematic circuit diagram illustrations of windings and inverter units of an inverter of the electric machine according to FIG. 2 and FIG. 4, respectively;

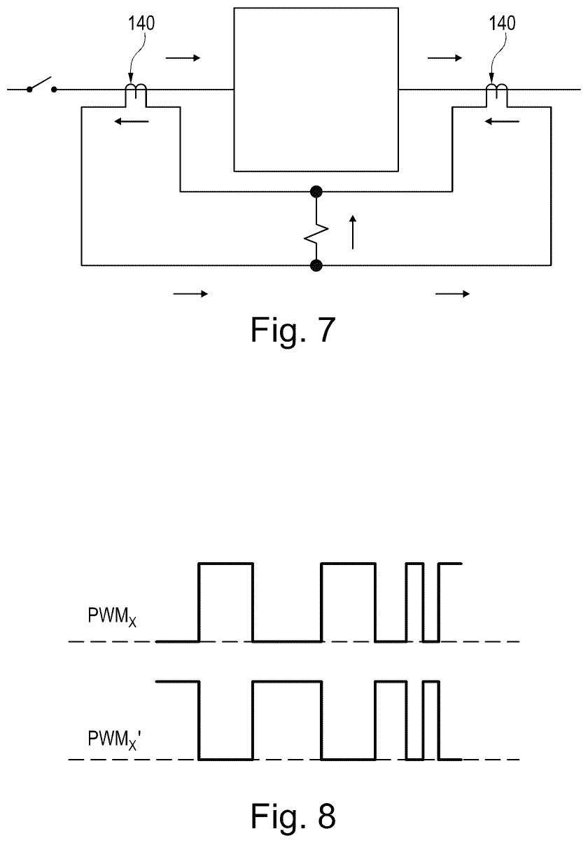

FIG. 7 shows a circuit diagram of a differential protection device;

FIG. 8 shows switching signals for the inverter units;

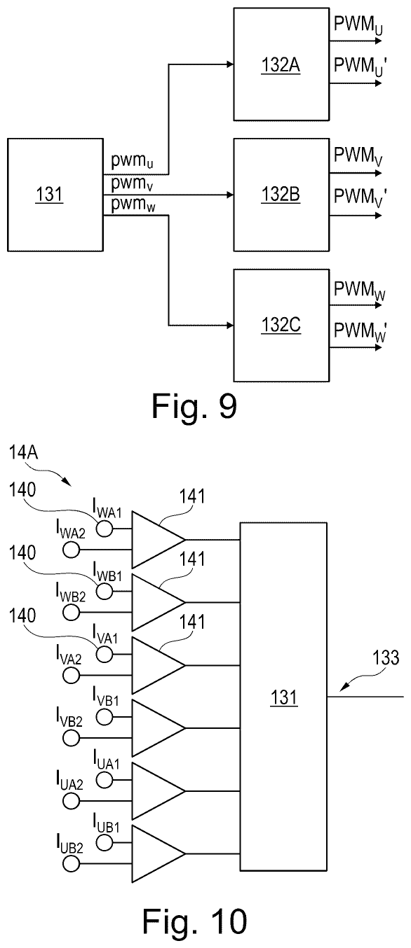

FIG. 9 shows a block diagram of components of the inverter;

FIGS. 10 to 12 show block diagrams of components of differential protection devices for the windings of FIGS. 5 to 7;

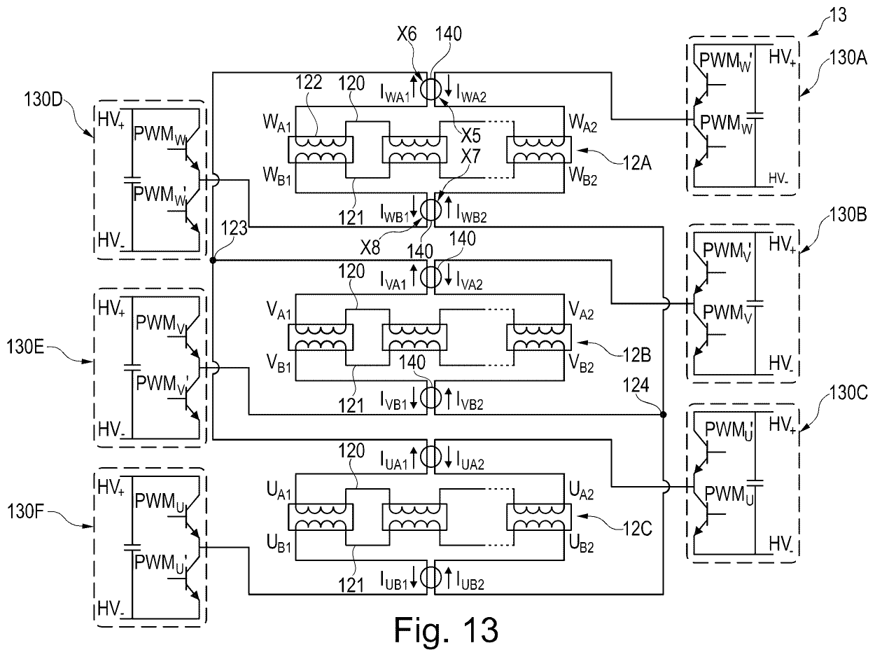

FIG. 13 shows a further schematic circuit diagram illustration of windings and inverter units of an inverter;

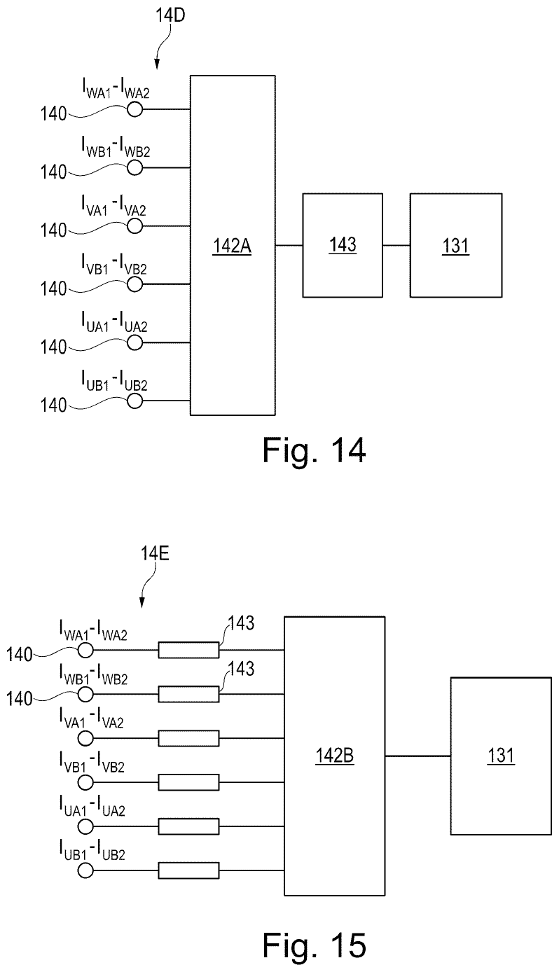

FIGS. 14 and 15 show block diagrams of components of differential protection devices for the windings of FIG. 13;

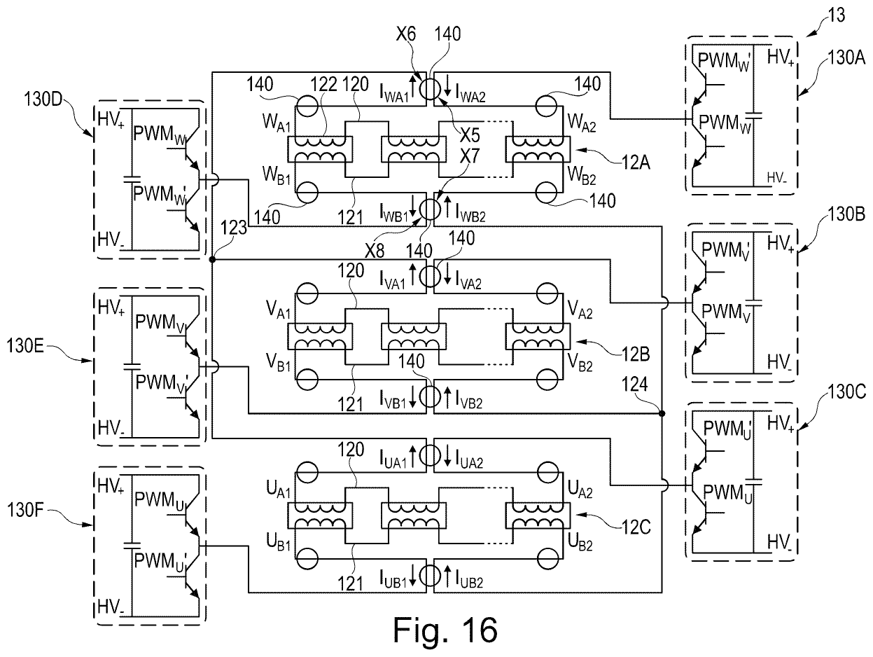

FIG. 16 shows a further schematic circuit diagram illustration of windings and inverter units of an inverter;

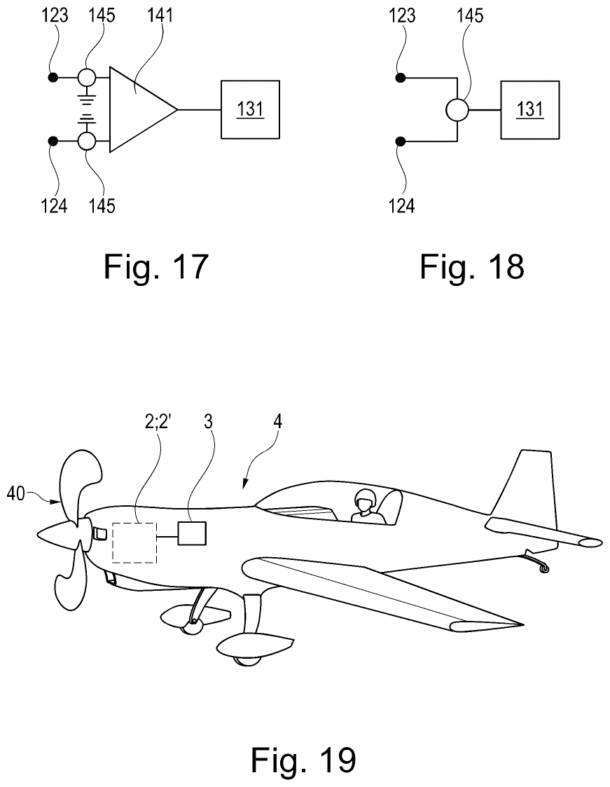

FIGS. 17 and 18 show block diagrams of arrangements for measuring voltage differences between star points, for example of one of the arrangements according to FIGS. 5-7 and 14;

FIG. 19 shows an aircraft in the form of an airplane having an electrically driven propeller and the electric machine;

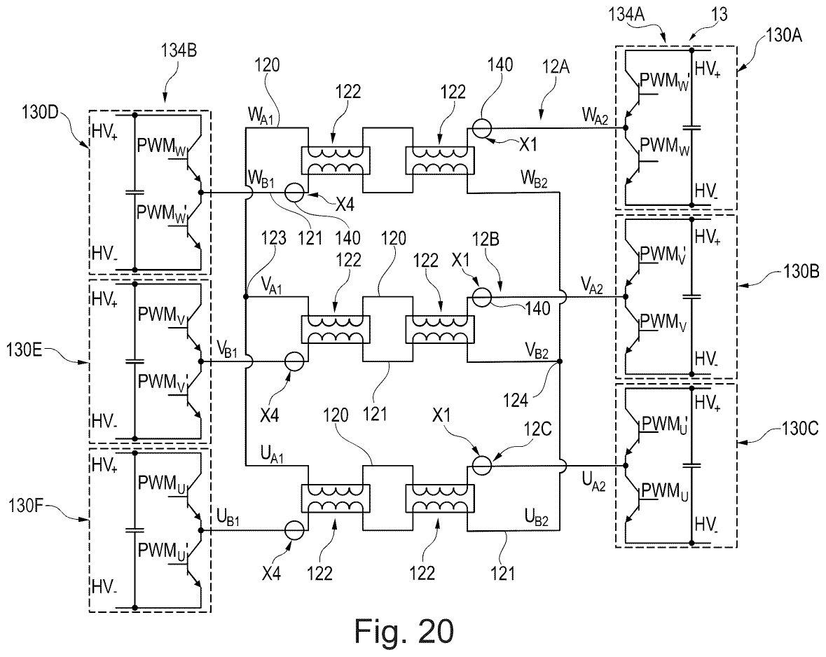

FIGS. 20 to 23 show schematic circuit diagram illustrations of windings and inverter units for the electric machine according to FIG. 2 and according to FIG. 4;

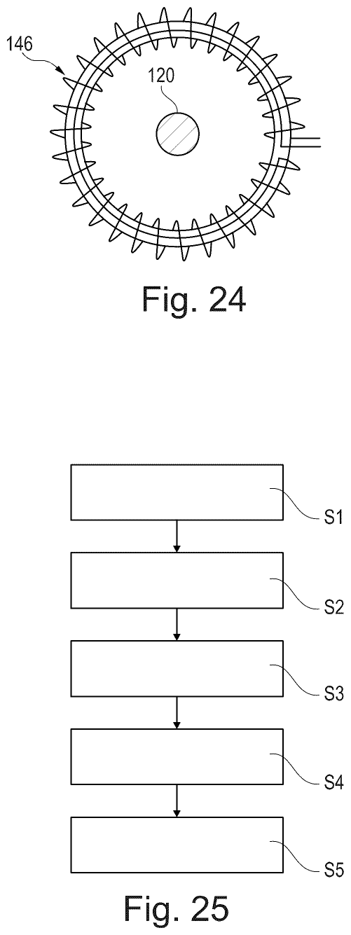

FIG. 24 shows a Rogowski coil; and

FIG. 25 shows a method for monitoring an electric machine.

FIG. 1 shows a schematic sectional illustration of a rotating electric machine 2 in the form of a permanently excited synchronous machine. It can be seen from FIG. 1 that the electric machine 2 in the present case is in the form of an internal rotor. The electric machine 2 comprises an arrangement 1 having an assembly in the form of a stator 21 which has an opening, in particular a through-opening, which is not denoted, in which a further assembly in the form of a rotor 20 is arranged in a rotatably mounted manner.

The stator 21 comprises a body 10 in the form of a laminated core, on which teeth are anchored, which are referred to below as stator teeth 11. The stator teeth 11 are aligned with an air gap L between the body 10 of the stator 21 and the rotor 20. The stator teeth 11 protrude radially from the body 10, in the present case radially inward. The stator 21 has a stator winding which comprises a plurality of windings, which in connection with the present example are referred to as tooth windings 12A-12C merely by way of example. In the present case, the stator winding is designed for three-phase operation, that is to say is connected to a three-phase AC voltage having phases U, V, W. During intended operation of the electric machine 2, the AC voltage is applied to the stator winding as appropriate. The electric machine is a radial flux machine, but it should be noted that the electric machine could also be designed as an axial flux machine or a transverse flux machine, for example. In particular, axial flux machine or transverse flux machine the electric machine can also be designed with a double air gap.

In the present case, the rotor 20 is in the form of a salient-pole rotor which comprises permanent magnets for providing the magnetic flux. In the present refinement, there is provision for the rotor 20 to have exactly one magnetic north pole N and one magnetic south pole S. In alternative refinements, more magnetic poles can also be provided in alternation in the circumferential direction transverse to an axis of rotation of the rotor 20 (relative to the stator 21).

The rotor 20 is rotatably mounted. As a result of the three-phase AC voltage, the phases U, V, W thereof each being phase-shifted by 120°, a magnetic rotating field is generated during intended operation, which magnetic rotating field interacts with the permanently excited magnetic field provided by the rotor 20 such that a corresponding rotational movement of the rotor 20 in relation to the stator 21 can be brought about in motor mode. In the present case, provision is made for the electric machine 2 to be used as a drive motor for a propeller of an aircraft. In the present case, the electric machine 2 is an electric motor. The portions of the stator winding which are assigned to the respective phases U, V, W are schematically illustrated in FIG. 1. One of the tooth windings 12A-12C is in each case respectively assigned to one of the phases U, V, W.

The stator winding of the electric machine 2 is connected to an inverter 13 of three-phase design of the arrangement 1. Together with the connected inverter 13 connected thereto, the arrangement 1 forms an electrical system. The inverter 13 provides the electrical AC voltage with the three phases U, V, W. The inverter 13 obtains the electrical energy required for the intended operation from an energy source 3 connected to the inverter 13. In the present refinement, the energy source 3 is a DC voltage source which provides electrical energy from a suitable electrical energy store, for example a rechargeable battery or the like. As an alternative or in addition, a fuel cell and/or the like or, in the case of stationary applications, also an energy supply from a public energy supply network can be provided, for which purpose a rectifier for converting an alternating current of the public energy supply network into direct current can be provided.

The inverter 13 has inverter units assigned for providing the phases U, V, W, which inverter units are explained in more detail further below in connection with FIG. 5, for example. In this case, each inverter unit has its own half-bridge circuit. The half-bridge circuits are connected to a DC link circuit, which is not illustrated any further in FIG. 1, of the inverter 13 in order to thus be supplied with electrical energy. The DC link circuits can have a voltage of 25 V or more, of 100 V or more or for example in the range from 800 to 3000 V.

It is noted here that the half-bridge circuit has a series circuit comprising two electronic switching elements (for example transistors) which are connected to the link circuit DC voltage of the inverter 13. The electronic switching elements are operated in a clock mode, as explained in more detail below in connection with FIG. 9, which provides clock patterns in the manner of a PWM signal, for example. The corresponding phase U, V, W of the three-phase AC voltage is then available at a respective center tap of the half-bridge circuits. Appropriate filtering is carried out by the inductance of the tooth windings 12A-12C, with the result that an appropriate alternating current is obtained for each of the phases U, V, W, which alternating current can be virtually sinusoidal if the inverter units are suitably controlled.

The arrangement 1 further comprises a unit, which is referred to here as control unit 131. In the example shown, the control unit 131 is (also) designed for controlling the inverter 13, but alternatively it could also be designed separately from an inverter control system.

In the present case, the inverter 13 is part of the electric machine 2, but together these can also be referred to as a machine-inverter system.

FIG. 2 shows a schematic exploded illustration of the stator 21 of the electric machine 2. It can be seen that the stator 21 has the body 10, in which stator teeth 11 can be assembled with the annular body 10 by means of a mechanical connection and can thus be anchored, in particular mechanically fixed, thereon. As an alternative, the stator teeth 11 are formed, for example, in a one piece with the body 10 and in this way anchored on it.

The stator teeth 11 are fitted with respective winding portions 122 of the tooth windings 12A-12C. The stator winding has a plurality of tooth windings 12A-12C, in the present case exactly three. A respective one of the tooth windings 12A-12C is generally arranged at least on one of the stator teeth 11. In the present case, each of the tooth windings 12A-12C extends over a plurality of, here two (specifically two opposite), stator teeth 11. For this purpose, the tooth windings 12A-12C generally each have at least one, here a plurality of, namely two, winding portions 122. Each winding portion 122 surrounds (exactly) one stator tooth 11.

Each of the tooth windings 12A-12C has a respective first electrical conductor 120 which, on each of the winding portions 122, is arranged in a plurality of turns circumferentially around the respective stator tooth 11. Between the winding portions 122, the first electrical conductor 120 comprises one or more corresponding connecting portions via which the portions of the first electrical conductor 120 at the winding portions 122 are electrically connected to each other.

Each of the tooth windings 12A-12C further has a respective second electrical conductor 121 which likewise at each of the winding portions 122 is arranged in a plurality of turns circumferentially around the respective stator tooth 11. Between the winding portions 122, the second electrical conductor 121 comprises one or more corresponding connecting portions via which the portions of the second electrical conductor 121 at the winding portions 122 are electrically connected to each other.

The first electrical conductors 120 and the second electrical conductors 121 each have end portions to which they are connected in a manner described in more detail below. Between the respective end portions, the first electrical conductors 120 and the second electrical conductors 121 are electrically insulated from each other. The tooth windings 12A-12C are connected up in the electric machine 2 as appropriate such that the three-phase connection to the inverter 13 is present.

FIG. 3 shows a schematic illustration of a winding portion 122 of one of the tooth windings 12A-12C. The first electrical conductor 120 in this case is wound around the stator tooth 11, which is not illustrated in FIG. 3. The winding on the stator tooth 11 extends here around and along a winding axis A. In the present case, the winding is designed in the form of an elongate coil along the winding axis A. Depending on the configuration and construction, there can also be provision for a multilayer winding to be provided in order to be able to achieve, for example, a correspondingly high magnetic potential with a predefined electrical current.

Furthermore, the winding portion 122 of the tooth winding 12A-12C comprises the respective second electrical conductor 121, which is electrically insulated from the first electrical conductor 120. The second electrical conductor 121 also has a plurality of turns arranged circumferentially around the same stator tooth 11, so that the winding on the stator tooth 11 extends around and along the winding axis A. The respective turns of the first and the second electrical conductors 120, 121 are arranged in a bifilar manner. That is to say that one turn of the first electrical conductor 120 is always arranged between two adjacent turns of the second electrical conductor 121 (and vice versa) along the winding axis A of the winding portion 122 (with the exception of the outermost two turns). This has the advantage that, in the event of a short circuit between two adjacently arranged turns, the short circuit between turns always occurs between the first electrical conductor 120 and the second electrical conductor 121. A short circuit between turns thus does not occur inside a winding of the same electrical conductor. This makes it possible to prevent large currents in the case of a short circuit between turns and therefore large thermal and electrical stresses.

Optionally, each first electrical conductor 120 and/or each second electrical conductor 121 consists of at least two individual conductors insulated from each other.

FIG. 4 shows a schematic illustration of an electric machine 2′ in the form of a synchronous machine which, in contrast to the electric machine 2 according to FIGS. 1 and 2, is now of twelve-pole rather than six-pole design. The corresponding stator therefore has twelve stator teeth 11. These are arranged equidistantly in the circumferential direction in the present case. The rotor 20 is again arranged in a through-opening formed through the stator, which rotor is likewise of twelve-pole design in this refinement and therefore provides six north poles N and six south poles S arranged in alternation in the circumferential direction. Here too, there is provision for the magnetic flux provided by the rotor 20 to be provided by permanent magnets arranged, for example, in the region of the outer circumference of the rotor 20.

Here too, each of the stator teeth 11 is equipped with a winding portion 122 of one of the three tooth windings. Each of the three tooth windings again has a respective first electrical conductor and a respective second electrical conductor (illustrated by different line thicknesses in FIG. 4 purely for the purposes of illustration) which are wound onto the respective stator teeth 11 in a bifilar manner. This electric machine 2′ is likewise designed to be supplied with a three-phase AC voltage, wherein each of the phases is again denoted using U, V, W.

FIG. 5 shows an electrical interconnection of the tooth windings 12A-12C and the inverter units 130A-130F of the inverter 13 of the electric machine 2 according to FIG. 1.

The (in the present case three) first electrical conductors 120 of the tooth windings 12A-12C form a first winding system and the (in the present case three) second electrical conductors 121 of the tooth windings 12A-12C form a second winding system. The first winding system is connected to three inverter units 130A-130C. The first electrical conductors 120 are each connected with an end portion WA2, VA2, UA2 to one of the inverter units 130A-130C. The respective other end portions WA1, VA1, UA1 of the first electrical conductors 120 are electrically connected to each other at a first star point 123. The second winding system is connected to three inverter units 130D-130F. The second electrical conductors 121 are each connected with an end portion WB1, VB1, UB1 to one of the inverter units 130D-130F. The respective other end portions WB2, VB2, UB2 of the second electrical conductors 121 are electrically connected to each other at a second star point 124.

The inverter 13 thus comprises six inverter units 130A-130F, two for each of the three phases U, V, W, and of these two, one each for the first winding system and one for the second winding system. As already described, each inverter unit 130A-130D has a half-bridge circuit. An optional capacitor complements the existing circuit with a low-pass filter.

A (in the present case the same) DC voltage (designated by HV+ and HV−) is applied to the inverter units 130A-130D of the inverter 13. For example, the DC voltage is 25 V or more, 100 V or more or 800 to 3000 V.

Furthermore, all six winding portions 122 for the six stator teeth 11 are shown, wherein each winding of the first and second electrical conductors 120, 121 is illustrated only schematically.

Initially, the tooth winding 12A for a first phase W will be considered. The tooth winding 12A comprises a first electrical conductor 120 and a second electrical conductor 121. Both electrical conductors 120, 121 extend over winding portions 122 on the same (two) stator teeth 11 but are insulated from one another. Both electrical conductors 120, 121 have the aforementioned two end portions WA1, WA2, WB1, WB2. Both electrical conductors 120, 121 are free of junctions between their end portions WA1, WA2, WB1, WB2. The electrical conductors 120, 121 each establish an electrical connection between the respective two end portions WA1, WA2, WB1, WB2. The winding portions 122 of the tooth winding 12A lie between the end portions WA1, WA2, WB1, WB2 of the electrical conductors 120, 121.

One end portion WA2 of the first electrical conductor 120 is electrically connected to a first inverter unit 130A of the inverter 13, and the other end portion WA1 of said first electrical conductor is electrically connected to the first star point 123. One end portion WB1 of the second electrical conductor 121 is electrically connected to a fourth inverter unit 130D of the inverter 13, and the other end portion WB2 of said second electrical conductor is electrically connected to a second star point 124.

The end portions of the first electrical conductor 120 of the tooth winding 12B for a second phase V are denoted using VA1 and VA2. One end portion VA2 of the first electrical conductor 120 is electrically connected to the inverter 13, specifically to a second inverter unit 130B thereof, and the other end portion VA1 of said first electrical conductor is electrically connected to the first star point 123.

The end portions of the second electrical conductor 121 of the tooth winding 12B for the second phase V are correspondingly denoted using VB1 and VB2. One end portion VB1 of the second electrical conductor 121 is electrically connected to the inverter 13, specifically to a fifth inverter unit 130E thereof, and the other end portion VB2 of said second electrical conductor is electrically connected to the second star point 124.

The end portions of the first electrical conductor 120 of the tooth winding 12C for a third phase U are denoted using UA1 and UA2. One end portion UA2 of the first electrical conductor 120 is electrically connected to the inverter 13, specifically to a third inverter unit 130C thereof, and the other end portion UA1 of said first electrical conductor is electrically connected to the first star point 123.

The end portions of the second electrical conductor 121 of the tooth winding 12C for the third phase U are correspondingly denoted using UB1 and UB2. One end portion UB1 of the second electrical conductor 121 is electrically connected to the inverter 13, specifically to a sixth inverter unit 130F thereof, and the other end portion UB2 of said second electrical conductor is electrically connected to the second star point 124.

The arrangement 1 further comprises a protection device described further below in more detail, in the present case in the form of a differential protection device. The differential protection device comprises a plurality of sensors for detecting an electrical variable, in the present case in the form of current sensors 140. Each of the current sensors 140 is arranged on the first or second electrical conductor 120, 121 and measures the current of the current flowing therein. In general, a current sensor 140 is arranged at each of at least two points of the first electrical conductor 120 and two points of the second electrical conductor 121 of at least one (or each) of the tooth windings 12A-12C. In the example shown, four current sensors are provided per tooth winding 12A-12C. The current sensors 140 each comprise a Hall sensor. Optionally, the Hall sensor is coupled to a ferromagnetic flux concentrator which, for example, surrounds the respective electrical conductor 120, 121 and optionally comprises a V-shaped tapered portion at the pointed end of which the Hall sensor is arranged.

For each of the tooth windings 12A-12C, a current sensor 140 is arranged at a first point X1 on the (first) electrical conductor 120. This (first) point X1 is located with respect to the electrical path between the end portion WA2 and the winding portion 122 closest to this end portion WA2 along the electrical path of the first electrical conductor 120. A further current sensor 140 is arranged at a (second) point X2 on the first electrical conductor 120. This (second) point X2 is located with respect to the electrical path between the end portion WA1 and the winding portion 122 closest to this end portion WA1 along the electrical path of the first electrical conductor 120. A further current sensor 140 is arranged at a (third) point X3 on the second electrical conductor 121. This (third) point X3 is located with respect to the electrical path between the end portion WB2 and the winding portion 122 closest to this end portion WB2 along the electrical path of the second electrical conductor 121. A further current sensor 140 is arranged at a (fourth) point X4 on the second electrical conductor 121. This (fourth) point X4 is located with respect to the electrical path between the end portion WB1 and the winding portion 122 closest to this end portion WB1 along the electrical path of the second electrical conductor 121.

Thus, with respect to the electrical paths, the winding portions 122 are each located between the current sensors 140. By ascertaining a difference (in particular in comparison with a threshold value) in the currents detected by the current sensors 140 at the first point X1 and the second point X2 and/or accordingly a difference between the third point X3 and the fourth point X4, the control unit 131 can identify a short circuit between turns and initiate a countermeasure by means of the differential protection device.

The control unit 131 is configured to detect a first difference in the currents (in general: the electrical variable) at the two points X1, X2 of the first electrical conductor 120 and a second difference in the electrical variable at the two points X3, X4 of the second electrical conductor 121 and to output an output signal based on a deviation between the first difference and the second difference.

In the second and third tooth windings 12B, 12C, the current sensors 140 are arranged corresponding to the first tooth winding 12A.

FIG. 6 shows substantially the same interconnection as FIG. 5, but with more winding portions 122 being illustrated. It can be seen that the tooth windings 12A-12C can have a smaller or larger number of winding portions 122 depending on the application, for example a total of six (cf. in particular FIGS. 2 and 5), twelve (cf. in particular FIG. 4) or 18.

While the tooth windings 12A-12C are arranged between the inverter units 130A-130F according to FIGS. 5 and 6, it is pointed out that this arrangement is only exemplary.

Furthermore, it can be seen that in FIGS. 5 and 6 the end portions, connected to the inverter units 130A-130F, of the first and second conductors 120, 121 of each individual one of the tooth windings 12A-12C face away from one another with respect to the common winding portions 122.

FIG. 7 shows a general design of a differential protection device, as may be provided in the stator 21. In general, the differential protection device compares two currents measured at different points.

A component to be monitored is illustrated here by a block. In the present case, this is the part of the first electrical conductor 120 or the second electrical conductor 121 of one of the tooth windings 12A-12C between its respective end portions. The current sensors 140 are formed here (optionally) as measuring coils with one or more turns which are arranged on the corresponding first/second electrical conductor, so that the current in the electrical conductor induces a current in the measuring coils. The measuring coils (or generally the current sensors 140) are connected in series in a closed circuit. If the currents induced in the two current sensors 140 are equal, then no current flows across a cross-connection between one and the other electrical connection of the current sensors 140. However, if a portion of the current flows through the monitored electrical conductor into the bifilar other electrical conductor, then there is a difference that results in a current in the cross-connection. This cross-current is monitored by the differential protection device and compared with a threshold value, for example. Based on this, a countermeasure can be initiated, for example an optional switch (for example in the form of a relay) can be opened in the electrical conductor.

Furthermore, as a countermeasure, a current introduced into the monitored electrical conductor 120, 121 can be changed, for example reduced or switched off, by controlling the transistors of at least the inverter unit 130A-130F connected thereto in a changed manner based on the detection of a differential current. The transistors are controlled by means of signals, in the present case by means of pulse width modulated signals, which can also be referred to as PWM signals for short (pulse width modulation). The PWM signals alternate between two discrete values, for example “on” and “off”, which open and close the corresponding transistor, respectively.

FIG. 8 shows an example of such PWM signals, wherein the X stands for the respective phase U, V, W. The PWM signals for the individual phases U, V, W are, for example, the same, only shifted in time.

Furthermore, an inverted PWMX′ signal is provided for each PWMX signal, which assumes a different discrete value in relation to the PWMX signal over time.

As illustrated, for example, with reference to FIGS. 5 and 6, for each of the tooth windings 12A-12C, the reverse PWM signal PWMW′, PWMV′, PWMU′ is applied to the transistor of the inverter unit 130A, 130B, 130C of the first electrical conductor 120 connected to the positive pole HV+ of the DC voltage. By contrast, the PWM signal PWMW, PWMV, PWMU is applied to the transistor of the inverter unit 130A, 130B, 130C of the first electrical conductor 120 connected to the negative pole HV− of the DC voltage.

In the second electrical conductors 121, the PWM signals are applied in reverse. The PWM signal PWMW, PWMV, PWMU is applied to the transistor of the inverter unit 130D, 130E, 130F of the second electrical conductor 121 connected to the positive pole HV+ of the DC voltage. By contrast, the reverse PWM signal PWMW′, PWMV′, PWMU′ is applied to the transistor of the inverter unit 130D, 130E, 130F of the second electrical conductor 121 connected to the negative pole HV− of the DC voltage.

It can therefore be seen that the same PWM signals are applied to the inverter units 130A-130C of the first electrical conductor 120 as to the inverter units 130D-130F of the second electrical conductor 121.

FIG. 9 illustrates the generation of the PWM signals and the reverse PWM signals. The control unit 131 of the inverter generates signals for the three phases U, V, W, which are designated here as pwmu, pwmv, pwmw. These are each provided to a power electronics driver 132A-132C, which generates the PWM signals and the reverse PWM signals for the corresponding phase U, V, W based on them. The power electronics drivers 132A-132C are (for example electrically) connected to the inverter units 130A-130F of the respective phase U, V, W.

FIG. 10 shows the protection device in the form of the differential protection device 14A of the arrangement 1 according to FIG. 1. The differential protection device 14A comprises the (total of 12) current sensors 140. The other components shown in FIG. 5 are not shown again here merely for simplified visualization. Furthermore, the differential protection device 14A comprises several comparators 141, in the present case six. Two current sensors 140 are connected to each comparator 141, which is shown here in simplified form by a line. For example, the current sensors 140 are each electrically connected to the respective comparator 141. The respective comparator 141 is connected to the current sensors 140 in such a way that it can detect the current signals provided thereby, which are indicative of the current in the corresponding electrical conductor 120, 121. The comparator 141 compares the current signals provided by the two current sensors 140 with each other and provides the comparison result as a difference signal to the control unit 131. If a predetermined condition is fulfilled, for example if a differential signal exceeds or falls below a threshold value, the control unit 131 detects a fault.

As long as (within the scope of measurement accuracy) the currents are: IUA1=IUA2; IUB1=IUB2; IVA1=IVA2; IVB1=IVB2; IWA1=IWA2; and IWB1=IWB2, there is no fault.

By detecting a current IUA1 (at point X2) unequal to a current IUA2 (point X1) and/or a current IUB1 (point X4) unequal to a current IUB2 (point X3) (or correspondingly for one of the other phases V, W), the control unit 131 identifies a short circuit between turns. If this applies to two phases simultaneously, the control unit 131 (optionally) identifies a short circuit between two phases.

When a fault is identified, the control unit 131 optionally switches off all PWM signals (for example to zero). Optionally, the positive and/or the negative pole HV+, HV− of the DC voltage source 3 are disconnected from the inverter units 130A-130F.

In the event of a short circuit between winding portions of the same phase, the control unit 131 optionally causes a three-phase short circuit.

The control unit 131 can thus detect whether (certain) first and second electrical conductors 120, 121 have a short circuit between turns. In this case, the control unit 131 provides, for example, correspondingly modified PWM signals and reversed PWM signals.

The signals of the current sensors 140 at the first point X1 and at the second point X2 are connected to a comparator 141 (more generally: are compared with each other). As an alternative or in addition (in particular for redundancy), the signals of the current sensors 140 at the third point X3 and at the fourth point X4 are connected to a further comparator 141 (more generally: are compared with each other). The comparison between one comparator 141 and the further comparator 141 can also be made by means of an additional comparator.

The control unit 131 has an output 133 at which the control unit 131 outputs the output signal.

The control unit 131 is configured, by way of example, to output an output signal which indicates a line fault (specifically a short circuit between turns) when the first difference and the second difference (in particular the respective magnitude) are greater than a specified difference threshold value and at the same time the deviation is smaller than a specified deviation threshold value. The differential threshold value is, for example, 5% of the nominal value of the current. For example, the control unit detects:

$$IUA 1 - IUA 2 = IUA 1 - 2 and$$

$$IUB 1 - IUB 2 = IUB 1 - 2 ,$$

$$IWA 1 - IWA 2 = IWA 1 - 2 and$$

$$IWB 1 - IWB 2 = IWB 1 - 2 , and also$$

$$IVA 1 - IVA 2 = IVA 1 - 2 and$$

$$IVB 1 - IVB 2 = IVB 1 - 2.$$

If there is no fault, the values IUA1-2, IUB1-2, IWA1-2, IWB1-2, IVA1-2 and IVB1-2 are all substantially equal to 0.

In the event of a short circuit between turns, the values of IUA1-2 and IUB1-2 (or IWA1-2 and IWB1-2 or IVA1-2 and IVB1-2) each have the same values different from 0. Small or brief differences, and also brief peak-like differences, can be caused by measurement inaccuracies or noise. In order to filter this out, the control unit 131 is configured to output the output signal only when the first difference and/or the second difference over a specified time period is greater than the specified difference threshold value. As an alternative or in addition, the control unit 131 is configured to detect the first difference and/or the second difference as a mean average (for example as a square mean value or by means of smoothing or filtering) over a time window of specified length that moves with it.

However, in the case of a defective current sensor 140, the values of IUA1-2 and IUB1-2 (or IWA1-2 and IWB1-2 or IVA1-2 and IVB1-2) may differ from each other. For example, IUA1-2 is equal to 0 and IUB1-2 is not equal to 0. The control unit 131 is therefore designed to determine a deviation in the first and the second difference (for example the values of IUA1-2 and IUB1-2).

Since these deviations can also be caused by measurement inaccuracies or noise (or else by offsets, nonlinearities or temperature dependencies), the control unit 131 is configured to output an output signal, which indicates a sensor fault, when the deviation is greater than a specified deviation threshold value. As an alternative or in addition, the control unit 131 is configured to output the output signal indicating a sensor fault only when the deviation over a specified time period is greater than the specified deviation threshold value. As an alternative or in addition, the control unit 131 is configured to detect a deviation as a mean average over a time window of specified length that moves with it.

In the event of a sensor fault, provision may be made for the control unit 131 to deactivate monitoring of the currents. The output signal can be displayed to a user, for example a pilot.

The control unit 131 can be designed to perform a spectral analysis of the detected electrical variables. For example, the control unit 131 is designed to analyze predetermined frequency ranges, in particular those in which the signal is clearer, instead of a threshold value of the raw signal, or in addition thereto. For this purpose, a digital or an analog bandpass filter can be used, for example.

Optionally, the control unit 131 additionally monitors the inverter units. Furthermore, the control unit 131 can monitor the current sum through the 3 phases, and if this deviates from 0, the control unit 131 can output an fault.

Furthermore, FIG. 10 shows a method for monitoring the electric machine 2; 2′, which comprises:
applying electric current to a plurality of tooth windings 12A-12C, each of which has a first electrical conductor 120 and a second electrical conductor 121 which are wound at least on one winding portion 122 along a winding axis A around the same tooth of a plurality of teeth 11 of the electric machine 2; 2′ anchored to the body 10 and alternate in the direction of the winding axis A;
detecting an electrical variable with each of a plurality of sensors 140, which are arranged at least at two points X1, X2, X5, X6 of the first electrical conductor 120 and two points X3, X4, X7, X8 of the second electrical conductor 121 of at least one of the tooth windings 12A-12C;
detecting, by means of the control unit 131, a first difference in the electrical variable at the two points X1, X2, X5, X6 of the first electrical conductor 120 and a second difference in the electrical variable at the two points X3, X4, X7, X8 of the second electrical conductor 121 and determining a deviation between the first difference and the second difference; and
outputting, by means of the control unit 131, an output signal based on the deviation at the output 133.

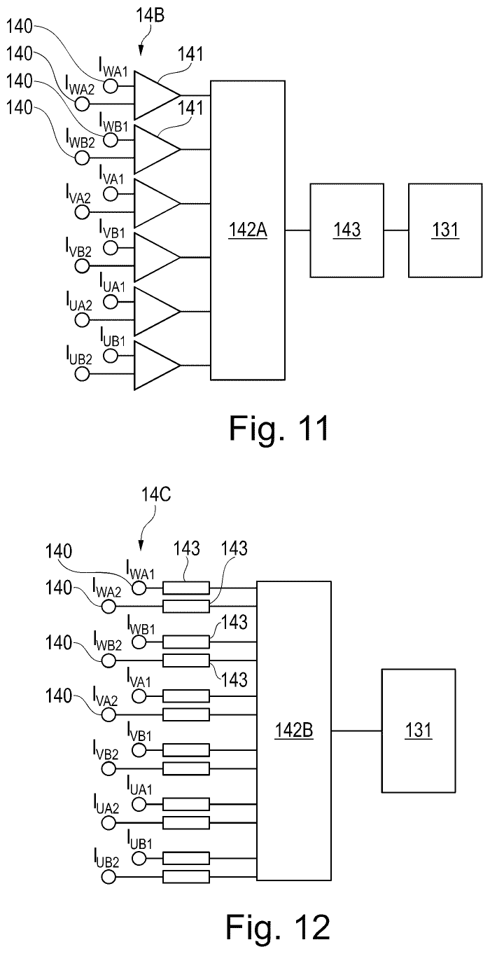

FIG. 11 shows a differential protection device 14B which can be provided in the arrangement 1 and is connected, for example, to the circuit according to FIG. 5 or 6. As in FIG. 10, the current sensors 140 are connected to the comparators 141. However, these provide their differential signals to an analog multiplexer 142A. The multiplexer 142A provides the differential signal of the individual comparators at its output, for example in chronological sequence (with a fixed frequency). This output is connected to an analog-to-digital converter, ADC 143. The ADC 143 converts the analog signals from the comparators into digital signals. These digital signals are output to the control unit 131. The control unit 131 can perform the comparison with the described threshold values and accordingly output a “0”, a “1” or a “2” at the output. A “1” then indicates, for example, a line fault, a “2” indicates a sensor fault and a “0” indicates a fault-free state. As an alternative, it is possible to compare the outputs of the comparators 141 with another comparator and to connect the output of this comparator to the analog multiplexer (for example multiplexer 142A).

Optionally, the multiplexer 142A, the ADC 143 and/or the control unit 131 are combined to form a microprocessor or SoC (system on a chip), for example, an 8-bit flash microcontroller. The control unit 131 comprises, for example, a vector control (field oriented control, FOC).

FIG. 12 shows a differential protection device 14C which can be provided in the arrangement 1 and is connected, for example, to the circuit according to FIG. 5 or 6. According to FIG. 12, the current sensors are each connected to one ADC 143 of a plurality of (here 12) ADCs 143. The outputs of the ADCs 143 are connected to a digital multiplexer 142B and its output is connected to the control unit 131.

FIG. 13 shows substantially the same design of the tooth windings 12A-12C and their connection to the inverter 13 as FIG. 6. In contrast, however, the portions of the electrical conductors 120, 121 between the end portions and the winding portions 122 are laid such that portions on either side of the winding portions 122 (with respect to the electrical path of the respective electrical conductors 120, 121) run adjacent (in particular antiparallel with respect to the direction of current flow) to each other, for example abut each other, at one point. This makes it possible to use only one current sensor 140 per electrical conductor 120, 121. In the present case, six current sensors 140 are therefore sufficient for monitoring all six electrical conductors 120, 121 of the phases U, V, W.

A current through the first electrical conductor 120 at a (first) point X5 of the first electrical conductor 120 (of each phase U, V, W) induces a current in a current sensor 140. A current through the first electrical conductor 120 at a (second) point X6 of the first electrical conductor 120 flows antiparallel in comparison with the other (first) point X5 and therefore induces a current in the same current sensor 140 with the opposite sign. If the currents at the two points X5, X6 are the same, the effectively induced current is zero. Thus, the current sensor 140 for measuring an effective differential current through the first conductor 120 is arranged at points X5, X6 of the first electrical conductor 120, which are electrically connected to each other via the winding portion 122.

Furthermore, a current through the second electrical conductor 121 at a (third) point X7 of the second electrical conductor 121 (of each phase U, V, W) induces a current in a further current sensor 140. A current through the second electrical conductor 121 at a (fourth) point X8 of the second electrical conductor 121 flows antiparallel in comparison with the other (third) point X7 and therefore induces a current in the same current sensor 140 with the opposite sign. If the currents at the two points X7, X8 are the same, the effectively induced current is equal to zero. Thus, the current sensor 140 for measuring an effective differential current through the second electrical conductor 121 is arranged at points X7, X8 of the second electrical conductor 121, which are electrically connected to each other via the winding portion 122.

FIG. 14 shows the corresponding differential protection device 14D which can be provided in the arrangement 1 and is connected to the circuit according to FIG. 13. The differential protection device 14D corresponds to the differential protection device 14B according to FIG. 12, wherein no comparators are required due to the current sensors 140 measuring the effective differential current.

FIG. 15 shows a differential protection device 14E which can be provided in the arrangement 1 and alternatively can be connected to the circuit according to FIG. 13. The differential protection device 14E corresponds to the differential protection device 14C according to FIG. 13, wherein only six ADCs 143 are required due to the current sensors 140 measuring the effective differential current.

It should be noted in general that the control unit 131 can initiate countermeasures, but alternatively it can also be provided that the fault is first displayed to a user, who can then activate one of the described countermeasures via an input means.

Furthermore, it should be noted that the current sensors 140 adjacent to the inverter units 130A-130D may optionally be integrated into the respective inverter unit 130A-130D, for example arranged in a housing of the inverter unit 130A-130D.

FIG. 16 shows the same design of the tooth windings 12A-12C and their connection to the inverter 13 as FIG. 13. Here, current sensors 140 are arranged both according to FIG. 6 and also according to FIG. 13. The control unit 131 can therefore detect first and second differences according to FIG. 6 and according to FIG. 13 and compare them with each other. For example, the control unit 131 ascertains a first deviation with the sensors arranged according to FIG. 6 and a second deviation with the sensors arranged according to FIG. 13. If the two deviations differ from each other, the control unit 131 detects a sensor fault and outputs a corresponding output signal.

As an alternative or in addition, the voltage can be measured at the star points 123 and 124. These voltages can be compared using one or more comparators 141, for example in each case in relation to a ground potential or another reference potential, as illustrated with reference to FIG. 17. The comparison result of the comparator 141 can be output to the control unit 131. As an alternative or in addition, the voltage between the two star points 123, 124 can be measured by means of a voltage sensor 145. This voltage can be output to the control unit 131, as illustrated with reference to FIG. 18.

FIG. 19 shows an aircraft 4 in the form of an electrically driven airplane. The aircraft 4 comprises a propeller 40 which is driven by the above-described electric machine 2 according to FIG. 2 (alternatively by the electric machine 2′ according to FIG. 4).

The aircraft 4 further comprises an energy source 3 in the form of an electric battery, fuel cell and/or generator. The electric machine 2 is supplied with energy by the energy source 3, wherein the energy source 3 is electrically connected to the inverter 13.

FIG. 20 shows a circuit similar to the one described above with reference to FIG. 5. The circuit comprises a plurality of, namely three, tooth windings 12A-12C, each comprising a first electrical conductor 120 and a second electrical conductor 121. The first electrical conductor 120 and the second electrical conductor 121 of each tooth winding are wound at least on one winding portion 122, here only by way of example on each of two winding portions 122 (connected in series), along a winding axis A around the same tooth 11 (in each case) (as described above). The first and the second electrical conductors 120, 121 alternate in the direction of the winding axis A.

The first electrical conductors 120 of the three tooth windings 12A-12C are electrically connected to each other at a first star point 123. The second electrical conductors 121 of the three tooth windings 12A-12C are electrically connected to each other at a second star point 124.

The inverter 13 comprises a first inverter arrangement 134A with three inverter units 130A-130C each one for a phase U, V, W of the three-phase AC voltage, and a second inverter arrangement 134B, with three further inverter units 130D-130F, also each one for a phase U, V, W of the three-phase AC voltage.

The two inverter arrangements 134A, 134B thus each have an inverter unit 130A-130F for each phase U, V, W of the three-phase AC voltage. Each of the three first electrical conductors 120 of the tooth windings 12A-12C is electrically connected to a respective inverter unit 130A-130C of the first inverter arrangement 134A and each of the three second electrical conductors 121 of the tooth windings 12A-12C is electrically connected to a respective inverter unit 130D-130F of the second inverter arrangement 134B.

The inverter arrangements 134A, 134B can be activated and deactivated independently of each other.

A sensor 140 for detecting measured values of an electrical variable of the respective electrical conductor 120, 121 is arranged on at least one of the electrical conductors 120, 121, here on each of the first and second electrical conductors 120, 121. In the present case, the sensors 140 are each in the form of current sensors, which are designed to measure a current flowing through the respective electrical conductor 120, 121. The sensors 140 are each arranged in or between the respectively assigned inverter unit 130A-130F and the winding portion 122 connected thereto that is next along the respective electrical conductor 120, 121. The sensors 140 are therefore each arranged on the driver side, that is to say on the inverter side, not on the star point side. The sensors 140 can be arranged close to the winding portion 122 or close to (or in) the respective inverter unit 130A-130F. Furthermore, the sensors 140 can be integrated into the respective inverter unit 130A-130F.

The arrangement 1 according to FIG. 1 can comprise the circuit according to FIG. 20.

The control unit 131 of the arrangement 1 is configured to receive the measured values of the sensors 140, based on one or more of the measured values to determine at least one value, which is indicative of a sum of the electrical variable of the first electrical conductor 120 and/or the second electrical conductor 121 (here: the current through the respective electrical conductor 120, 121). Furthermore, the control unit 131 is configured to output an output signal based on the at least one value.

In the present case, the control unit 131 (for example periodically) detects the measured values of the sensors 140. This control unit then adds up the measured values of the currents of the three first conductors 120. Furthermore, the control unit 131 adds the measured values of the currents of the three second conductors 120. The control unit 131 (optionally) divides the two sums by three and thus obtains the respective zero sequence current for the first electrical conductors 120 and for the second electrical conductors 121:l0=1/3*(lu+lv+lw).

The control unit 131 then compares the two received zero sequence currents with a predetermined threshold value. If none of the zero sequence currents exceeds the threshold value, the control unit 131 assumes that the system is operating correctly and, optionally, outputs an appropriate output signal. If one of the zero sequence currents exceeds the threshold value and the other does not, the control unit 131 assumes a sensor error or other measurement error. The control unit outputs this with an output signal indicating a sensor error. If, on the other hand, both zero sequence currents exceed the threshold value, then the control unit 131 assumes a short circuit and outputs this with an output signal indicating an insulation fault.

Instead of the zero sequence currents, the control unit 131 can also evaluate variables proportional thereto, for example directly the sums obtained as described above.

By measuring two zero sequence currents, redundant and tested fault identification is possible, as is identification of the type of fault. If at least one of the zero sequence currents exceeds the threshold value, the control unit 131 identifies a fault. The use of the zero sequence components allows particularly simple and at the same time reliable fault identification.

The sensors 140 are, for example, current transducers.

It should be noted that the sensors 140 can be arranged inside the electric machine or can be arranged outside the electric machine.

Optionally, the control unit 131 ascertains harmonic frequencies of the zero sequence currents. The control unit 131 can identify a fault from a change in the harmonic frequencies. An analog or digital bandpass filter can be applied to the measured values.

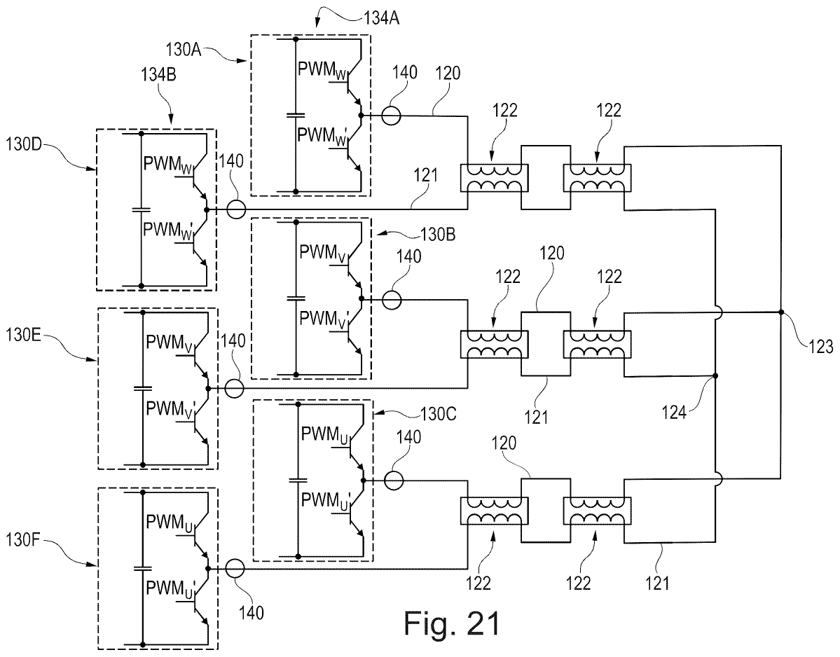

FIG. 21 shows substantially the same circuit as FIG. 20. However, whereas provision is made according to FIG. 20 for the star points 123, 124 to be arranged on different (mutually opposite) sides of the body 10, FIG. 21 illustrates that the first star point 123 and the second star point 124 are arranged on the same side of the body 10. Such an arrangement may optionally also be provided for the other circuits described herein, and alternatively an arrangement on opposite sides is possible.

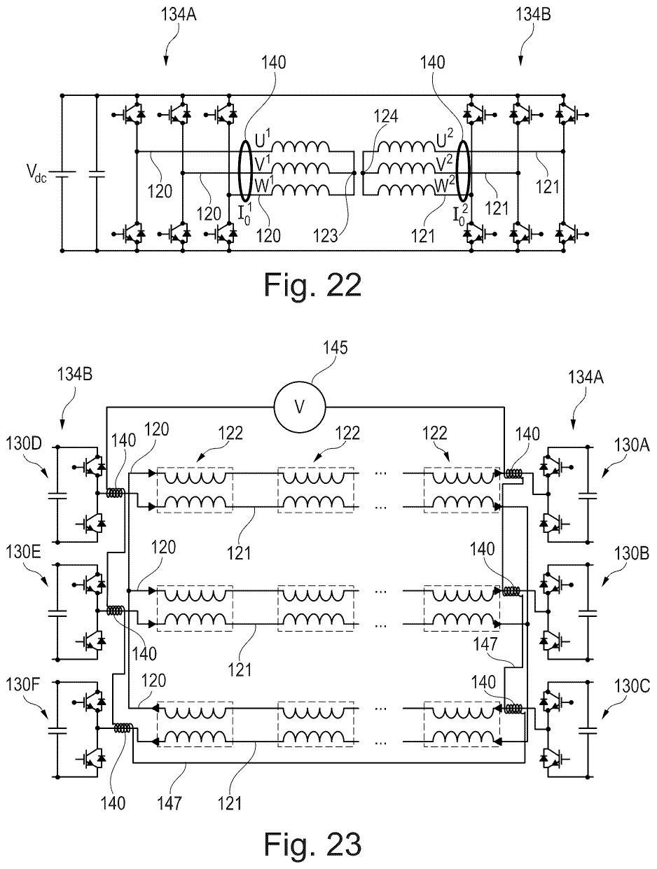

FIG. 22 illustrates a circuit which is substantially designed as illustrated with reference to FIG. 20, wherein the windings of the first electrical conductors 120 and the second electrical conductors 121 are shown spaced apart only for reasons of illustration. In the arrangement 1, these conductors, as well as those in the circuits of FIGS. 20 and 21, are provided in a bifilar manner on the teeth. Reference is made to the above statements with regard to the function and connection of the circuit.

According to FIG. 22, provision is made for a sensor 140, again in the form of a current sensor, to surround the three first electrical conductors 120. A further sensor 140 surrounds the three second electrical conductors 121.

Thus, the two current sensors 140 already measure the sum of the currents through the three first electrical conductors 120 and through the three second electrical conductors 121 using hardware. The control unit 131 can therefore directly compare the measured value (or a variable calculated therefrom) from each of the two sensors 140 with a corresponding threshold value in order to thus, as described above, identify a fault state.

FIG. 23 shows a circuit as described above in connection with FIG. 6, so that reference is made to the above embodiments in order to avoid repetition. The sensors 140 are arranged as explained above in connection with FIG. 20. The sensors 140 are designed, by way of example, in the form of coils around the respective electrical conductor 120, 121.

According to FIG. 23, provision is made for the sensors 140 of the first electrical conductors 120 to be connected to each other in series. Provision is further made for the sensors 140 of the second electrical conductors 120 to be connected to each other in series, however, as shown in FIG. 23, with reverse polarity in comparison with the sensors of the first electrical conductors 120. In this way, the sum of the measured values is already calculated by the type of interconnection.

Provision is further made for the two series circuits to be electrically connected to each other in series via a connecting line 147. A voltage sensor 145 measures the voltage difference at the two open conductor ends of the series circuit. During fault-free operation, the measured voltage difference is less than a specified threshold value. If the measured value output by the voltage sensor 145 exceeds the threshold value, then the control unit 131 assumes an insulation fault.

The sensors 140 are arranged on the driver side according to FIGS. 21, 22 and 23 too.

The sensors 140 described, for example, with reference to the various figures, can be each designed in the form of a Rogowski coil 146, as shown in FIG. 24 by way of example. The Rogowski coil 146 surrounds the respective electrical conductor (here the first electrical conductor 120 merely by way of example). The Rogowski coil 146 comprises a wire wound into a coil shape, with the turns of the coil running around the conductor 120. A return conductor runs around the conductor 120 on the coil back to the starting point.

FIG. 25 illustrates a method for monitoring an electric machine 2; 2′, comprising:

Step S1: Applying electric current to a plurality of tooth windings 12A-12C, each of which has a first electrical conductor 120 and a second electrical conductor 121 which are wound at least on one winding portion 122 along a winding axis A around the same tooth of a plurality of teeth 11 of the electric machine 2; 2′, the teeth being anchored on a body 10, and alternate in at least one direction, in particular in the direction of the winding axis A, by means of a first inverter arrangement 134A with inverter units 130A-130C and a second inverter arrangement 134B with further inverter units 130D-130F, wherein the inverter arrangements 134A, 134B each have an inverter unit 130A-130F for each phase U, V, W of a polyphase electrical AC voltage, wherein each of the first electrical conductors 120 of the tooth windings 12A-12C is electrically connected to an inverter unit 130A-130C of the first inverter arrangement 134A and each of the second electrical conductors 121 of the tooth windings 12A-12C is electrically connected to an inverter unit 130D-130F of the second inverter arrangement 134B and wherein the first electrical conductors 120 of the tooth windings 12A-12C are electrically connected to each other at a first star point 123 and the second electrical conductors 121 of the tooth windings 12A-12C are electrically connected to each other at a second star point 124.

Step S2: Detecting an electrical variable of one or more of the first or second electrical conductors 120, 121 with each of one or more sensors 140.

Step S3: Receiving, by means of a control unit 131, the measured values of the sensor 140 or the sensors 140.

Step S4: Determining, by means of the control unit 131, at least one value, which is indicative of a sum of the electrical variable of the first electrical conductors 120 and/or the second electrical conductors 121 based on one or more of the measured values. For example, the value is equal to the sum of the currents.

Step S5: Outputting, by means of a control unit 131, an output signal based on the at least one value.

It goes without saying that the invention is not limited to the embodiments described above and various modifications and improvements can be made without deviating from the concepts described here. Any of the features may be used separately or in combination with any other features, unless they are mutually exclusive, and the disclosure extends to and includes all combinations and subcombinations of one or more features that are described herein.

### LIST OF REFERENCE SIGNS

1 Arrangement
10 Body
11 Tooth (stator tooth)
12A-12C Winding (tooth winding)
120 First electrical conductor
121 Second electrical conductor
122 Winding portion
123 First star point
124 Second star point
13 Inverter
130A-130F Inverter unit
131 Unit (control unit)
132A-132C Power electronics driver
133 Output
134A, 134B Inverter arrangement
14A-14E Protection device (differential protection device)
140 Sensor (current sensor)
141 Comparator
142A, 142B Multiplexer
143 Analog-to-digital converter
144 Adder
145 Voltage sensor
146 Rogowski coil
147 Connecting line
2; 2′ Electric machine
20 Assembly (rotor)
21 Assembly (stator)
3 Energy source
4 Aircraft
40 Propeller
A Winding axis
L Air gap
N North pole
S South pole
U, V, W Phase
X1-X8 Point

1.-30. (canceled)

31. An arrangement for an electric machine, the arrangement comprising:
an assembly having a body and a plurality of windings, wherein each winding of the plurality of windings has a first electrical conductor and a second electrical conductor that are wound at least on one winding portion along a winding axis and alternate in at least one direction;
a plurality of sensors arranged at least at two points of the first electrical conductor and two points of the second electrical conductor of at least one winding of the plurality of windings in order to detect an electrical variable in each case; and
a unit configured to:
detect a first difference in the electrical variable at the two points of the first electrical conductor and a second difference in the electrical variable at the two points of the second electrical conductor; and
output an output signal based on a deviation between the first difference and the second difference.

32. The arrangement of claim 31, wherein the plurality of sensors is configured as a plurality of current sensors for measuring a current through respective electrical conductors.

33. The arrangement of claim 31, wherein the at least two points of the respective electrical conductor are electrically connected to each other via the respective winding portion.

34. The arrangement of claim 31, wherein the unit is further configured to output the output signal when the deviation is greater than a specified deviation threshold value, and
wherein the output signal indicates a sensor fault.

35. The arrangement of claim 31, wherein the unit is further configured to:
output an output signal, which indicates a line fault, when: (1) at least one of a magnitude of the first difference or a magnitude of the second difference is greater than a specified difference threshold value; and (2) the deviation is less than a specified deviation threshold value; or
output the output signal only when the magnitude of the first difference and/or the magnitude of the second difference over a specified time period is greater than the specified difference threshold value.

36. The arrangement of claim 31, wherein the unit is further configured to detect at least one of the first difference or the second difference as a mean average over a specified time window or extract a predetermined frequency range from values of the detected electrical variable by bandpass filtering.

37. The arrangement of claim 31, wherein a first sensor of the plurality of sensors is arranged at one point of the at least two points of the first electrical conductor,
wherein a second sensor of the plurality of sensors is arranged at a further point of the at least two points of the first electrical conductor,
wherein a third sensor of the plurality of sensors is arranged at one point of the at least two points of the second electrical conductor, and
wherein a fourth sensor of the plurality of sensors is arranged at a further point of the at least two points of the second electrical conductor.

38. The arrangement of claim 31, wherein a sensor of the plurality of sensors for measuring a differential current of the first electrical conductor is arranged at points of the first electrical conductor that are electrically connected to each other via the winding portion, and
wherein a further sensor of the plurality of sensors for measuring a differential current of the second electrical conductor is arranged at points of the second electrical conductor that are electrically connected to each other via the winding portion.

39. The arrangement of claim 31, further comprising:
an inverter with a plurality of inverter units, wherein each inverter unit of the plurality of inverter units is configured for one electrical phase of a polyphase electrical AC voltage,
wherein each electrical conductor of the first and second electrical conductors of the plurality of windings is electrically connected to the inverter.

40. The arrangement of claim 31, wherein the plurality of windings comprises three or more windings,
wherein each winding of the three or more windings is for one phase of a three-phase or polyphase alternating current, and
wherein the first electrical conductors of the plurality of windings are electrically connected to each other at a first star point and/or the second electrical conductors of the plurality of windings are electrically connected to each other at a second star point.

41. The arrangement of claim 31, wherein the first and the second electrical conductor of each winding of the plurality of windings are arranged in a bifilar manner at least on the winding portion, and
wherein each electrical conductor of the first electrical conductors of the plurality of windings runs around a plurality of teeth of the body in each case and each electrical conductor of the second electrical conductors of the plurality of windings runs around the same teeth in each case.

42. An arrangement for an electric machine, the arrangement comprising:
an assembly having a body and a plurality of windings, wherein each winding of the plurality of windings has a first electrical conductor and a second electrical conductor that are wound at least on one winding portion along a winding axis and alternate in at least one direction, wherein the first electrical conductors of the plurality of windings are electrically connected to each other at a first star point, and wherein the second electrical conductors of the plurality of windings are electrically connected to each other at a second star point;
a first inverter arrangement with inverter units; and
a second inverter arrangement with further inverter units, wherein the first and second inverter arrangements each have an inverter unit for each phase of a polyphase electrical AC voltage, wherein each electrical conductor of the first electrical conductors of the plurality windings is electrically connected to an inverter unit of the first inverter arrangement, and wherein each electrical conductor of the second electrical conductors of the plurality of windings is electrically connected to an inverter unit of the second inverter arrangement;
one or more sensors for detecting measured values of an electrical variable of one or more of the first or second electrical conductors; and
a unit configured to:
detect the measured values of at least one sensor of the one or more sensors;
determine at least one value indicative of a sum of the electrical variable of at least one electrical conductor of the first electrical conductor or the second electrical conductor, based on one or more of the measured values; and
output an output signal based on the at least one value.

43. The arrangement of claim 42, wherein the unit is further configured to ascertain the value as a first zero sequence current of the first electrical conductors or ascertain a further value as a second zero sequence current of the second electrical conductors.

44. The arrangement of claim 43, wherein the unit is further configured to:
identify a fault on one of the first conductors when the first zero sequence current exceeds a specified threshold value;
identify a fault on one of the second conductors when the second zero sequence current exceeds a specified threshold value, wherein the output signal indicates a fault when the unit has identified at least one of a fault on one of the first conductors or a fault on one of the second conductors;
identify a presence of a first type of fault either when there is a fault on one of the first conductors or there is a fault on one of the second conductors; and
identify a presence of a second type of fault when there is a fault on one of the first conductors and a fault on one of the second conductors, wherein the output signal indicates a fault when the unit identifies the first type of fault, and indicates an insulation fault when the unit identifies the second type of fault.

45. The arrangement of claim 42, wherein one sensor of the one or more sensors is arranged on each electrical conductor of the first and second electrical conductors,
wherein each sensor of the one or more sensors is arranged between a respective inverter unit and a respective next winding portion connected to the respective inverter unit,
wherein the one or more sensors of the first electrical conductors is connected in series and the one or more sensors of the second electrical conductors is connected in series, and
wherein the two series are electrically connected to each other with reverse polarity at one end and are connected to a voltage sensor at the other end.

46. The arrangement of claim 42, wherein one sensor of the one or more sensors surrounds the first electrical conductors, and
wherein one sensor of the one or more sensors surrounds the second electrical conductors.

47. The arrangement of claim 42, wherein the first star point and the second star point are arranged on a same side of the body.

48. The arrangement of claim 42, wherein at least one sensor of the one or more sensors is configured as a current sensor for measuring a current through the respective electrical conductor, and
wherein each current sensor comprises a Rogowski coil.

49. The arrangement of claim 42, wherein the unit is further configured to:
determine at least one harmonic of the value over time; and
output the output signal based on a change in the at least one harmonic.

50. A method for monitoring an electric machine, the method comprising:
applying electric current to a plurality of windings, wherein each winding of the plurality of windings has a first electrical conductor and a second electrical conductor that are wound at least on one winding portion along a winding axis and alternate in at least one direction;
detecting an electrical variable with each sensor of a plurality of sensors, which are arranged at least at two points of the first electrical conductor and two points of the second electrical conductor of at least one winding of the plurality of windings;
detecting, by a unit, a first difference in the electrical variable at the two points of the first electrical conductor and a second difference in the electrical variable at the two points of the second electrical conductor and determining a deviation between the first difference and the second difference; and
outputting, by the unit, an output signal based on the deviation.
